(19) United States
(12) Patent Application Publication
(10) Pub. No.: US 2012/0320206 A1
(43) Pub. Date: Dec. 20, 2012

(54) SYSTEM AND METHOD FOR TRACKING A LEAD OBJECT

(76) Inventors: Chern-Horng Sim, Singapore (SG); Weng Heng Chua, Singapore (SG); Choon Boon Tan, Singapore (SG); Chee Hwee Toh, Singapore (SG)

(21) Appl. No.: 13/328,309

(22) Filed: Dec. 16, 2011

(30) Foreign Application Priority Data
Dec. 21, 2010 (SG) 201009485-2

(51) Int. Cl. G06K 9/62; H04N 7/18; H04N 5/33; H04N 5/225

(52) U.S. Cl. 348/148; 348/169; 348/164; 382/103; 348/E07.085; 348/E05.024; 348/E05.09

(57) ABSTRACT

An imaging system for tracking the location and direction of movement of a first object comprises a plurality of marker devices adapted to be disposed in a pattern on the first object, a sensing device, and a processor. The sensing device is adapted to be disposed on a second object so as to view the marker devices, the sensing device being operative to detect the relative positions of the plurality of marker devices on the first object, and the processor is coupled to the sensing device to form an image of the relative positions of the plurality of marker devices and to determine the direction of movement of the first object.

### FIELD OF THE INVENTION

The present invention relates to an imaging system for vehicles. More particularly, it relates to an imaging system for tracking the direction of movement of a first object with respect to a second object.

### BACKGROUND OF THE INVENTION

Vehicle convoys are widely used for a vast variety of applications. In military applications, vehicle convoys are used to transport resources or re-supplies to remote operation areas. Convoys of tipper trucks are also used in the construction industry to carry material back and forth from work sites for commercial purposes.

Night convoy operations in the military are typically used for sensitive operations where the convoy may be passing through a dangerous zone or is in a danger zone. The conditions in such operations are usually marked with limited visibility as the vehicles are required to be tactical in their movement. Typically, such operations are vulnerable to sniper attacks, ambush from roadside bombs, or improvised explosive devices (IEDs) from insurgents.

To circumvent the problem of limited visibility in convoy applications, it is known to use imaging, sensors, or homing systems.

U.S. Pat. No. 5,249,128 discloses a method and system for range detection using a passive infrared sensing device. The method includes determining a region on a moving object, such as an automobile, the region having a size characteristic of the object. The next step is to characterize the region by a plurality of feature points and sense the energy emitting from these feature points. The distance between the sensing device and the moving object can be calculated. The method and system, however, provides only for calculating the distance between a first and a second moving object and is dependent upon the driver to make changes if necessary during movement.

U.S. Pat. No. 6,466,306 discloses a method using night vision devices based upon image intensification technology for judging distance from an object to detect relative positions of signals from at least two spaced apart marker devices formed on that object. An image of the relative positions of the markers is created within a field of view. Images of the markers are viewed through a reticle adaptor by the operator to judge the distance. The judging of the distance is based on fitting the marker images onto the pre-marked line on the viewer. The system, however, is heavily reliant on the driver of the follower vehicle to ensure that the leader vehicle is maintained within the safe distance. Further, the system does not provide a way to track and estimate the path of the leader vehicle if it is outside the field of view.

U.S. Patent Publication No. 2006/0221328 discloses an automatic homing system, operable between pairs of objects. One or both of the objects in the pair may be moving and/or unmanned. The method comprises the steps of emitting light of at least two different frequencies and automatically detecting the emitted light. Such a system however, makes use of light sources such as incandescent lamps, light emitting diodes (LEDs), light pipes, laser diodes, etc, which are not tactical in dangerous territory.

U.S. Pat. No. 6,759,949 discloses an imaging system for a motor vehicle comprising a far infra-red camera disposed at the front end of a vehicle adapted for detecting thermal radiation and producing an image signal indicative of the temperature of the surrounding objects. A digital signal processor receives the image signal and selectively enhances the temperature resolution based upon the relative temperature distribution of the image signal, which is proportional to the temperature of objects emitting in the infrared region. The system, however, does not provide for tracking and estimating the path of a leader vehicle.

There is, therefore, a need for an imaging system that is able to track and estimate the path of a lead vehicle in low visibility conditions.

Any discussion of documents, devices, acts or knowledge in this specification is included to explain the context of the invention. It should not be taken as an admission that any of the material forms a part of the state of the art or the common general knowledge in the relevant art on or before the priority date of the disclosure and claims herein. All statements as to the date or representation as to the contents of these documents is based on the information available to the applicant and does not constitute any admission as to the correctness of the date or contents of these documents.

### OBJECTS OF THE INVENTION

It is an object of the present invention to overcome, or at least substantially ameliorate, the disadvantages and shortcomings of the prior art.

It is also an object of the invention to provide an imaging system for tracking the direction of movement of a first object, comprising
a plurality of marker devices adapted to be disposed on the first object; and
a sensing device adapted to be disposed on a second object,
wherein the sensing device is adapted for detecting the relative positions of the plurality of marker devices on the first object.

It is a further object of the invention to provide an imaging system for tracking the direction of movement of a first object, comprising
a plurality of marker devices adapted to be disposed on the first object; and
a sensing device adapted to be disposed on a second object,
wherein the sensing device is adapted for detecting the relative positions of the plurality of marker devices on the first object and for forming an image of the relative positions of the plurality of marker devices.

It is a yet further object of the invention to provide an imaging system for tracking the direction of movement of a first object, comprising
a plurality of marker devices adapted to be disposed on the first object; and
a sensing device adapted to be disposed on a second object,
wherein the sensing device is adapted for detecting the relative positions of the plurality of marker devices on the first object and forming an image of the relative positions of the plurality of marker devices, and
wherein the relative positions of the marker devices on the image allows the rotation of the first object about its own axis to be determined such that the path of the first object can be tracked.

It is a yet further object of the invention to provide a method for tracking the direction of movement of a first object, comprising the steps of:
receiving images of relative positions of a plurality of marker devices adapted for being disposed on the first object, said images being captured from a sensing device adapted for being disposed on a second object;
obtaining from the images parameters based on the relative positions of the plurality of marker devices; and
processing the parameters to obtain the distance, bearing, and rotation of the first object with respect to the second object such that the direction of movement of the first object with respect to the second object can be determined.

It is a yet further object of the invention to provide a method for tracking the direction of movement of a first object, relevant to a second object, which method comprises:
generating signals regarding relative positions of a plurality of marker devices disposed on the first object;
receiving said signals in a sensing device disposed on the second object;
providing images based upon said signals in a display;
obtaining from the images parameters based on the relative positions of the plurality of marker devices; and
processing the parameters to obtain the distance, bearing, and rotation of the first object with respect to the second object such that the direction of movement of the first object with respect to the second object can be determined.

Other objects and advantages of the present invention will become more apparent from the description below.

### SUMMARY OF THE INVENTION

According to the present invention, an imaging system for tracking the direction of movement of a first object comprises a plurality of marker devices adapted to be disposed on the first object and a sensing device adapted to be disposed on a second object. The sensing device detects the relative positions of the plurality of marker devices on the first object and forms an image of the relative positions of the plurality of marker devices. The relative positions of the marker devices on the image allow the rotation of the first object about its own axis to be determined such that the direction of movement of the first object can be tracked.

The first object comprises a plurality, that is, at least one or two or more, marker devices. Preferably there are at least four marker devices, spaced apart from each other at substantially equal distances. For example, if there are four marker devices, they would form a square or a diamond. A substantially square configuration is preferred. Preferably the marker devices are mounted on the rear end of the first object.

In a preferred embodiment of the invention, a digital processing unit is operatively connected to the sensing device. The digital processing unit obtains at least one parameter from the image for determining the distance, bearing, or rotation of the first object about its own axis with respect to the second object. The parameters include horizontal distance in number of pixels between the marker devices and/or vertical distance in number of pixels between the marker devices.

Preferably one or more of the plurality of marker devices emit infrared energy. At least one of the plurality of marker devices comprises a conductive plate, a temperature controller, and a power controller module. The conductive plate maintains a temperature difference between the temperature of the first object and the conductive plate such that the sensing device can detect the marker devices on the first object. Preferably the temperature difference is at least 10° C.

The temperature controller regulates the temperature of the conductive plate by heating or cooling the conductive plate such that a temperature difference between the temperature of the first object and the conductive plate is maintained.

A typical application of the invention may be a situation where the leader vehicle is manned or inhabited and the follower vehicle is unmanned or uninhabited. However, either vehicle can be manned or unmanned.

According to the invention, a method for tracking the direction of movement of a first object comprises the steps of:
receiving images of relative positions of a plurality of marker devices adapted for disposing on the first object, said images captured from a sensing device adapted for disposing on a second object;
obtaining from the images parameters based on the relative positions of the plurality of marker devices;
processing the parameters to obtain the distance, bearing and rotation of the first object with respect to the second object such that the direction of movement of the first object with respect to the second object can be determined.

In one embodiment of the invention, an imaging system for tracking the location and direction of movement of a first object comprises:
a plurality of marker devices adapted to be disposed in a pattern on the first object;
a sensing device adapted to be disposed on a second object so as to view the marker devices, the sensing device being operative to detect the relative positions of the plurality of marker devices on the first object; and a processor coupled to the sensing device to form an image of the relative positions of the plurality of marker devices and to determine the direction of movement of the first object.

In another embodiment of an imaging system of the invention, the plurality of marker devices comprises at least four marker devices.

In another embodiment of an imaging system of the invention, each of the marker devices is spaced apart from each other.

In another embodiment of an imaging system of the invention, the distances between each of the marker devices are substantially equal.

In another embodiment of an imaging system of the invention, the marker devices are arranged in a substantially square configuration, with one marker device in each corner.

In another embodiment of an imaging system of the invention, a digital processing unit is operatively connected to the sensing device, wherein the digital processing unit obtains at least a parameter from the image for determining the distance, bearing, or rotation of the first object about its own axis with respect to the second object.

In another embodiment of an imaging system of the invention, the parameters include horizontal distance in number of pixels between the marker devices.

In another embodiment of an imaging system of the invention, the parameters include vertical distance in number of pixels between the marker devices.

In another embodiment of an imaging system of the invention, the plurality of marker devices emits infrared energy.

In another embodiment of an imaging system of the invention, at least one of the plurality of marker devices comprises a conductive plate, a temperature controller, and a power controller module.

In another embodiment of an imaging system of the invention, the conductive plate maintains a temperature difference between the temperature of the first object and the conductive plate such that the sensing device can detect the marker devices on the first object.

In another embodiment of an imaging system of the invention, the temperature difference is in the range of from about 10° to 50° C.

In another embodiment of an imaging system of the invention, the temperature controller regulates the temperature of the conductive plate by heating or cooling the conductive plate such that a temperature difference between the temperature of the first object and the conductive plate is maintained.

In another embodiment of an imaging system of the invention, each of the first object and the second object is an unmanned or manned vehicle.

In another embodiment of an imaging system of the invention, the marker devices are removably mounted on the rear end of the first object.

In another embodiment of an imaging system of the invention, the relative positions of the marker devices on the image allows the rotation of the first object about its own axis to be determined such that the direction of movement of the first object can be tracked.

In another embodiment of the invention, an imaging system for tracking the direction of movement of a first object comprises:
a plurality of marker devices adapted to be disposed on the first object; and
a sensing device adapted to be disposed on a second object,
wherein the sensing device is adapted for detecting the relative positions of the plurality of marker devices on the first object and forming an image of the relative positions of the plurality of marker devices.

In another embodiment of the invention, a method for tracking the direction of movement of a first object comprises the steps of:
receiving images of relative positions of a plurality of marker devices adapted for disposing on the first object, said images captured from a sensing device adapted for disposing on a second object;
obtaining from the images parameters based on the relative positions of the plurality of marker devices;
processing the parameters to obtain the distance, bearing and rotation of the first object with respect to the second object such that the direction of movement of the first object with respect to the second object can be determined.

In another embodiment of a method the invention, the plurality of marker devices includes at least four marker devices.

In another embodiment of a method of the invention, the plurality of marker devices are each spaced apart from each other.

In another embodiment of a method of the invention, the plurality of marker devices are arranged in a substantially square configuration, with one device located in each corner.

In another embodiment of a method of the invention, the parameters include the horizontal distance in number of pixels of the marker devices.

In another embodiment of a method of the invention, the parameters include the vertical distance in number of pixels of the marker devices.

In another embodiment of a method of the invention, a method for tracking the direction of movement of a first object, relevant to a second object, comprises:
generating signals regarding relative positions of a plurality of marker devices disposed on the first object;
receiving said signals in a sensing device disposed on the second object;
providing images based upon said signals in a display;
obtaining from the images parameters based on the relative positions of the plurality of marker devices; and
processing the parameters to obtain the distance, bearing, and rotation of the first object with respect to the second object such that the direction of movement of the first object with respect to the second object can be determined.

This invention may also be said broadly to consist in the parts, elements and features referred to or indicated in the specification of the application, individually or collectively, and any or all combinations of any two or more of said parts, elements or features, and where specific integers are mentioned herein which have known equivalents in the art to which this invention relates, such known equivalents are deemed to be incorporated herein as if individually set forth.

### BRIEF DESCRIPTION OF DRAWINGS

In order that the invention may be better understood and put into practical effect, reference will now be made to the accompanying drawings, in which:

FIG. 1 is a schematic representation of the present invention in use in a leader-follower object situation according to a preferred embodiment;

FIG. 2 is a rear view of the leader object according to a preferred embodiment of the present invention;

FIG. 3 is a cross-sectional view of a marker device according to a preferred embodiment of the present invention;

FIG. 4a is a perspective view of a sensing device according to a preferred embodiment of the present invention;

FIG. 4b is a schematic diagram of a digital processing unit according to a preferred embodiment of the present invention;

FIG. 5 illustrates the geometric relationships involved in determining the distance, bearing, and tilt of the leader object with respect to the follower object according to a preferred embodiment of the present invention;

FIG. 6 is a corresponding image of the position of the marker devices in FIG. 5;

FIG. 7 is a plan view of the field of view of the sensing device with respect to the tilt of the leader vehicle about its central axis; and

FIG. 8 is a corresponding image view of the same tilt of the leader vehicle about its central axis in FIG. 7.

### DETAILED DESCRIPTION OF THE INVENTION

The present invention will now be described in detail in connection with preferred embodiments with reference to the accompanying drawings.

The present invention provides for an imaging system operating between at least a first object and a second object, comprising a plurality of marker devices disposed on the first object, and a sensing device 22 to detect an image of the marker devices, where the sensing device is disposed on the second object, and wherein the second object can track and estimate the path of the first object. Examples of the objects are, for example, ground vehicles, watercraft, aircraft, space craft, self-propelled objects, etc and in which both objects may be different. The respective objects may be manned or unmanned in any combination.

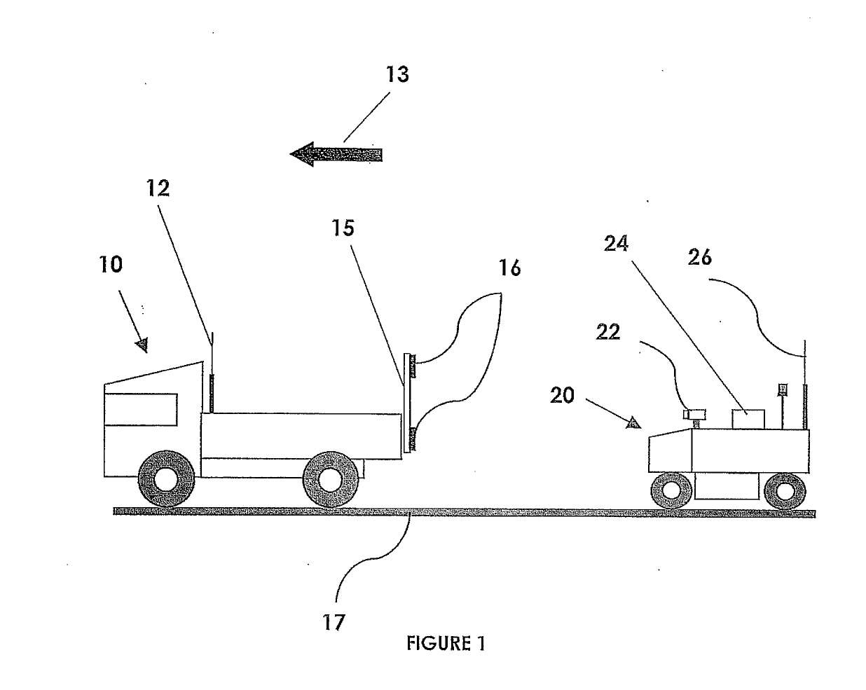

FIG. 1 is a schematic representation of a preferred embodiment of the present invention wherein two ground vehicles 10, 20 are travelling in a specified direction 13 along a surface 17. The vehicle behind, or the follower vehicle, 20 is equipped with an imaging system of the present invention, including a sensing device 22, and a display (not shown). Sensing device 22 is adapted to detect relative positions of at least one marker device 16 on the vehicle in front, or the leader vehicle, 10. Sensing device 22 may be a far-infrared camera (FIR), a thermal imaging camera, a long-wave infrared electro-optic imaging system, a night vision device, or any other suitable viewing device for the purpose of detecting generated signals on the leader vehicle. The leader and follower vehicles 10, 20 are also equipped with communication means 12, 26. Such communication means 12, 26 may be in the form of radio communication devices to allow interaction or an interface for other communication devices. As shown in FIG. 1, communication means 12, 26 are adapted for placement in a suitable location on leader and follower vehicles 10, 20.

Sensing device 22 may be mounted on the front end of the follower vehicle 20. For the purposes of maintenance, servicing, or security purposes, sensing device 22 may be removably detachable from the body of follower vehicle 20.

The display unit (not shown) is adapted for communication with sensing device 22 via a digital processing unit 24 and may be disposed within follower vehicle 20 in a suitable position. The display unit will be understood by a person skilled in the art as a screen or any other means capable of displaying relevant information to an operator and will therefore not be elaborated. The display unit may be located above the steering wheel inside the passenger compartment of the vehicle and is disposed in such a manner that the vehicle operator is not severely limited in his or her field of view. The display unit may also be integrated with any other communication device, for example, a video monitor, that may provide visual data to the operator. The display unit displays the processed output parameters of the sensing device and communicates to the vehicle operator of follower vehicle 20 meaningful information which may include the distance, bearing, or tilt of leader vehicle 10.

Alternatively, the processed output parameters of the digital processing unit 24 may be transmitted via a communication interface to a display unit in a remote location, for example, a ground control station or a base station. This may be in cases where follower vehicle 20 may be unmanned.

A plurality, that is, more than one or at least two, of marker devices 16 may be disposed on leader vehicle 10. Preferably, marker devices 16 are disposed in a manner that is within the line of sight or field of view of sensing device 22 of follower vehicle 20. Marker devices 16 may be mounted on a mounting bracket 15 adapted for connection at the rear end of leader vehicle 10. Alternatively, marker devices 16 may be adapted for connection to the rear end of leader vehicle 10. The output signals from marker devices 16 must be compatible with, that is capable of being received by, sensing device 22.

To allow for tactical movement when in use, a marker device 16 is preferably one that generates signals that are not detectable by the enemy or not visible to the human eye. The signal generated from a marker device 16 is preferably in the form of thermal or infrared radiation.

In use, sensing device 22 detects thermal radiation on follower vehicle 20 from marker devices 16 and produces an image signal indicative of the temperature or temperatures of marker devices 16. Digital processing unit 24 receives the image signal and maps the signal into a display signal in which marker devices 16 are evident to the operator on a display unit. The display unit may display the output parameters where the operator may adjust the position of follower vehicle 20 in a manner to maintain convoy distance. In instances where leader vehicle 10 is out of the line of sight of sensing device 22 of follower vehicle 20, the imaging system will display output parameters that will enable the operator of follower vehicle 20 to track and estimate the path of leader vehicle 10 to regain convoy position. More particularly, the distance, bearing, and tilt of leader vehicle 10 will be displayed. The method of tracking and estimating the path and/or position of leader vehicle 10 will be explained in further detail below.

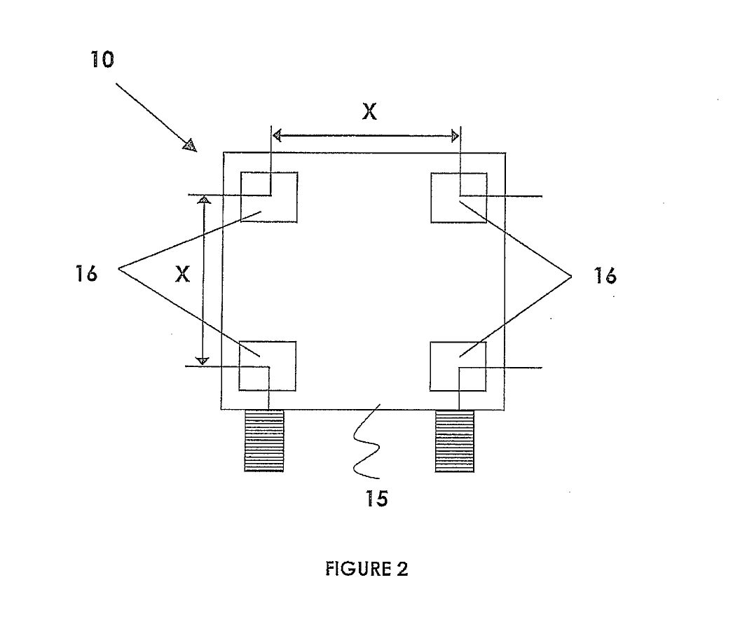

FIG. 2 represents a rear end view of leader vehicle 10 and the arrangement of marker devices 16 in a preferred embodiment of the invention. Marker devices 16 are arranged in a manner such that they are spaced apart from each other. It is preferred that at least four marker devices are used. Preferably, they are disposed on the outer perimeter of a mounting bracket 15. They may also be adapted to be mounted on the rear end of leader vehicle 10. As will be explained below, it is preferable that marker devices 16 are spaced substantially symmetrically and equidistantly from each other. The distance (X) between each of marker devices 16 from each other is preferably in the range of from about 300 to about 23,500 mm. Alternatively, other configurations that allow sensing device 22 to detect all the marker devices 16 are also possible. An equilateral triangle is an example of another useful configuration.

As the leader and follower vehicles 10, 20 are required to remain tactical while on the move, particularly during the night or in areas of limited visibility, it is important that they are not easily detected by enemies or insurgents. Accordingly, such marker devices 16, when in active or passive mode, are not visible to the naked eye, so as not to attract undue attention.

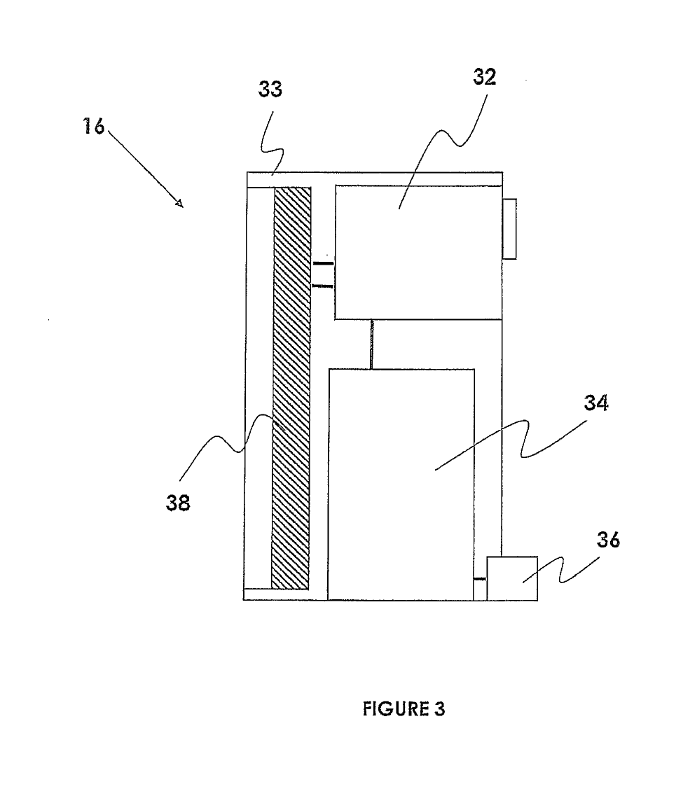

FIG. 3 represents a cross-sectional view of an active marker device 16 in an embodiment of the present invention. Marker device 16 may also be a passive infrared emitting light source. In a preferred embodiment of the present invention, marker device 16 utilizes active infrared emitting light sources, for example, a thermal energy emitting device. Examples of passive marker devices include thermal plates, color markers, LEDs, etc.

Marker device 16 includes a housing 33, a conductive plate 38 for heating and cooling, a temperature controller 32, and a power controller module 34. Each of the marker devices 16 may be powered by a vehicle source or an external power source, as represented by power source 36. Marker devices 16 allow sensing device 22 to detect the infrared energy emitted from a marker device 16 and to allow the operator of follower vehicle 20 to determine the distance, bearing, and tilt of lead vehicle 10.

In use, a marker device 16 may be heated or cooled depending upon the environmental conditions, to allow the sensing device to accurately detect the thermal energy emitted from the marker device 16. For example, when the environmental conditions are cool, at a temperature less than 20° C., the marker device 16 may be programmed to heat the conductive plate 38 such that the temperature of the marker device 16 is increased to a temperature higher than that the ambient temperature or the temperature of leader vehicle 10. The purpose of heating and cooling the conductive plate 38 of marker device 16 is to maintain a temperature difference between the temperature of leader vehicle 10 and the infrared energy emitted from marker device 16. The advantage of conductive plate 38 in the active marker device 16 is to enhance the thermal images displayed on the display unit. The temperature difference between leader vehicle 10 (or ambient temperature) and conductive plate 38 will enable sensing device 22 to detect and to therefore display clearly and accurately the thermal radiation from each marker device 16. For efficient display of the thermal images on the display unit, the temperature difference between leader vehicle 10 (or ambient temperature) and conductive plate 38 should be at least 10° C.

Temperature controller 32 ensures that the required temperature difference between leader vehicle 10 and conductive plate 38 is maintained and prevents the conductive plate from overheating.

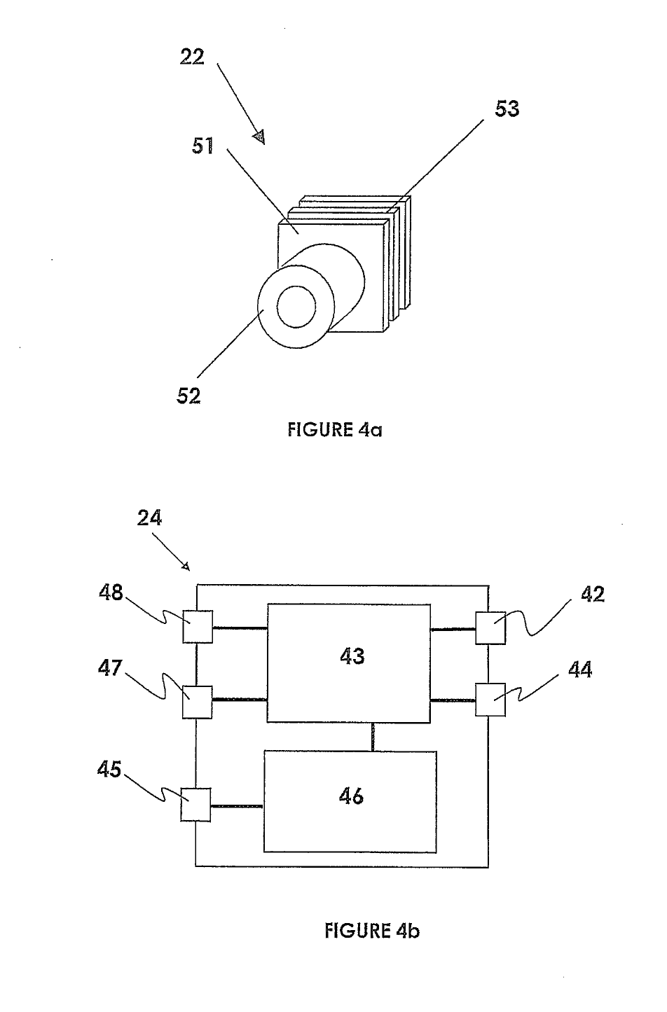

FIG. 4a is a close up view of a sensing device 22 in a preferred embodiment of the present invention. Sensing device 22 includes a charge coupled device (CCD) or a complementary metal-oxide-semiconductor (CMOS) enabled board 51 for capturing signals or images from a lens 52, a circuit board 53, and an input output means (not shown) for interface with other communication devices.

FIG. 4b represents a digital processing unit 24 for communicating the image signals from sensing device 22 to the display unit. Digital processing unit 24 includes a power module 46, a processing computer 43 for processing the images or signal, and a plurality of input-output (I/O) ports (42, 44, 45, 47, 48) for communicating with other devices. The I/O ports may be adapted for connection to devices such as the display unit, sensing device 22, or other wireless communication devices for transmitting images to a base station.

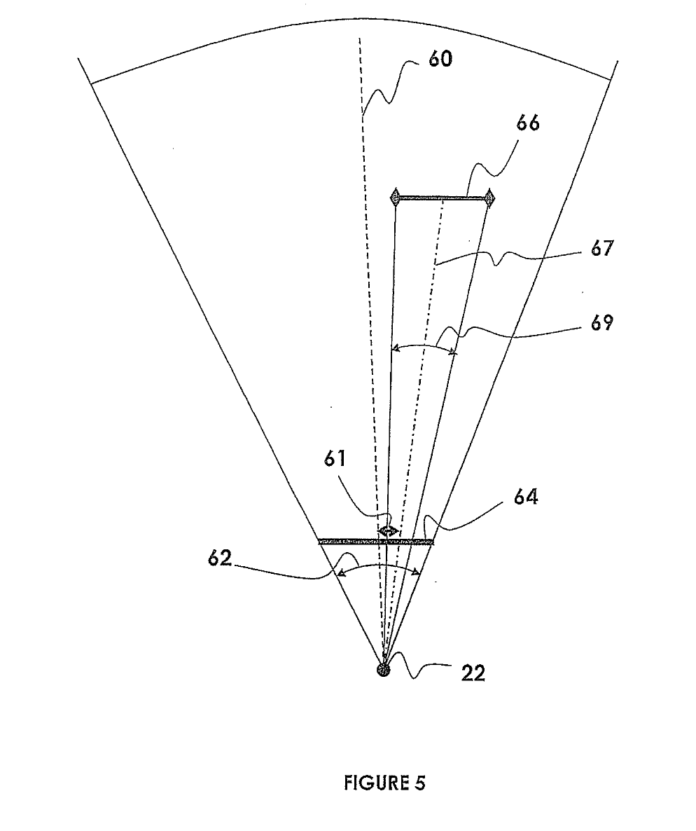

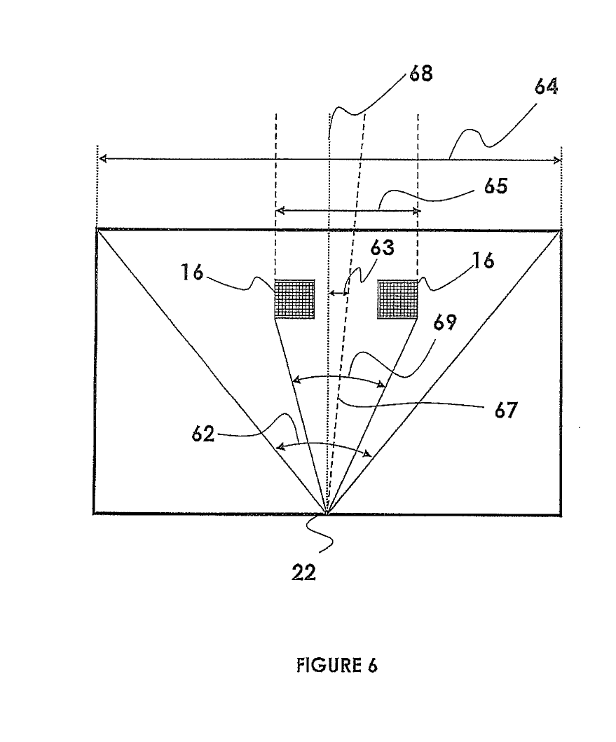

FIG. 5 is an illustration of the field of view of sensing device 22 and marker devices 16 when they are within the field of view or line of sight of sensing device 22. FIG. 6 shows a view of the corresponding image with respect to marker devices 16 and from the view of sensing device 22.

The method of determining the distance, bearing, and tilt of the leader vehicle will be explained hereinafter.

In use, the display unit will display various parameters to the operator on the current status of follower vehicle 20. The parameters displayed may be the distance, bearing, and tilt of leader vehicle 10 with respect to follower vehicle 20. Although the display unit will have a visual image of marker devices 16, the parameters displayed will give the operator a quantifiable output which allows the operator to control follower vehicle 20 in a manner that supports operational efficiency or requirements of the mission. For example, if follower vehicle 20 must maintain a distance of 15 meters from leader vehicle 10, the display unit will display to the operator in real time the actual distance from leader vehicle 10.

There may be occasions when leader vehicle 10 is not within the field of view or line of sight of follower vehicle 20. In this case, the display unit will immediately alert the operator of follower vehicle 20 that contact with leader vehicle 10 has been lost.

With reference again to FIG. 5, the horizontal field of view 62 (Hfov) is the field of view of sensing device 22. This is represented by sensing device 22 and the two lines projecting at an angle from the sensing device. The field of view 62 of sensing device 22 is dependent on the specifications of sensing device 22 and is generally fixed. The field of view 62 may be in the range of from about 25 to about 40 degrees. A dotted line 60 projecting from sensing device 22 represents the midpoint of the horizontal field of view 62. Typically, this calculation is half of the horizontal field of view.

The horizontal line 64 disposed in front of sensing device 22 represents the image width resolution of sensing device 22. The image width resolution (Wₚᵢₓₑₗ) is defined as the number of pixels lying on the width of the image. The image width resolution is dependent on the specification of sensing device 22. Typical image width resolution of sensing devices range from about 100 to about 500 pixels. In use, sensing device 22 captures an image of the marker devices 16 within the field of view at a given moment in time. The horizontal distance 66 between two of the marker devices 16 on the image itself is determined and is known as the horizontal distance of two horizontal marker devices 65 (HorDpixel). This distance is measured in pixels.

The actual distance of the two marker devices 16 measured horizontally 66 (HorD_{actual}) is predetermined. The actual horizontal distance 66 (HorD_{actual}) of the two marker devices is the distance 66 between the marker devices mounted on the leader object.

To obtain the distance between marker devices 16 and sensing device 22, i.e., the distance between the follower object and the leader object, the angle of view (A) 69 of two marker devices 16 from the sensing device is first obtained. The angle of view (A) 69 is measured in degrees. As the angle of view (A) 69 of two marker devices 16 is a function of the relationship between the image width resolution 64 and the horizontal field of view 62 (H_{fov}), the angle of view (A) of two marker devices 16 is obtained by the following calculation:

A=(H_{fov}×HorDₚᵢₓₑₗ)/Wₚᵢₓₑₗ

Once the angle of view (A) of two marker devices is obtained, the distance between the sensing device and the marker devices can be obtained by the following calculation:

Distance=HD_{actual}/A

To minimize errors from the calculations, the above calculations are repeated numerous times to obtain the average distance obtained. The calculations are typically repeated from two to four times.

The imaging system also allows the operator to know the bearing of the leader object with respect to the sensing device 22 mounted on the follower object. The bearing 61 measures the given position of the leader object with respect to the follower object at a given point in time. The bearing 61 is measured in degrees with respect to the central axis of the follower object. In use, the bearing 61 allows the operator of the follower object to maneuver the follower object according to operational or tactical requirements. For example, if the display unit displays the bearing as 30 degrees, it will be understood by the operator that the leader object is travelling in a direction 30 degrees with respect to the central axis of the follower object.

The bearing of the leader object with respect to the follower vehicle is determined and computed by the digital processing unit. With reference to FIG. 6, the bearing is represented as a function of the relationship with the horizontal field of view 62 (Hfov). As mentioned above, the horizontal field of view is dependent on the specification of the sensing device. This is therefore a known value. To determine the bearing, the pixel deviation 63 from the image centre is required. FIG. 6 shows a vertical dotted line through the image centre 68. The image centre is determined from half of the horizontal field of view and is measured in degrees. The pixel deviation from the image centre is the deviation of the end of the marker device in number of pixels from the centre of the image. The larger pixel deviation from the image centre is used for the calculation of the bearing 61 since it represents the movement of the marker device from the centre of the image. The calculation of the bearing is therefore as follows:

Bearing=[Pixel Deviation from the image center/(Wₚᵢₓₑₗ/2)]×(H_{fov}/2)

The imaging system can also determine the tilt or the rotation of the leader object about the central axis of the leader object. In operation, due to the low visibility to satisfy tactical movement, it may not be possible for the operator to regain convoy path of leader vehicle 10, even without use of the imaging system. However, the display unit will be able to display the last known tilt reading of leader vehicle 10 before leader vehicle 10 is completely out of the field of view of sensing device 22. The last known tilt reading or readings of leader vehicle 10 will provide the operator with a good probability that leader vehicle 10 is travelling in a specified direction which allows follower vehicle 20 to regain the convoy path. The tilt reading displayed on the display unit therefore provides the operator of the follower vehicle an advantage in regaining convoy path when leader vehicle is not within the field of view of the sensing device.

The tilt reading allows the operator of follower vehicle 20 to determine the direction or the path along which leader vehicle 10 is moving. In use, when leader vehicle 10 is in the field of view of sensing device 22, the tilt reading allows the operator of follower vehicle 20 to determine that leader vehicle 10 is making a left turn or a right turn to an accurate degree from the central axis 70 of leader vehicle 10. This is particularly useful and advantageous in cases where leader vehicle 10 has veered out of sight of sensing device 22 of follower vehicle 20 or marker devices 16 are no longer detectable by sensing device 22. The calculation of the tilt is hereinafter explained in detail.

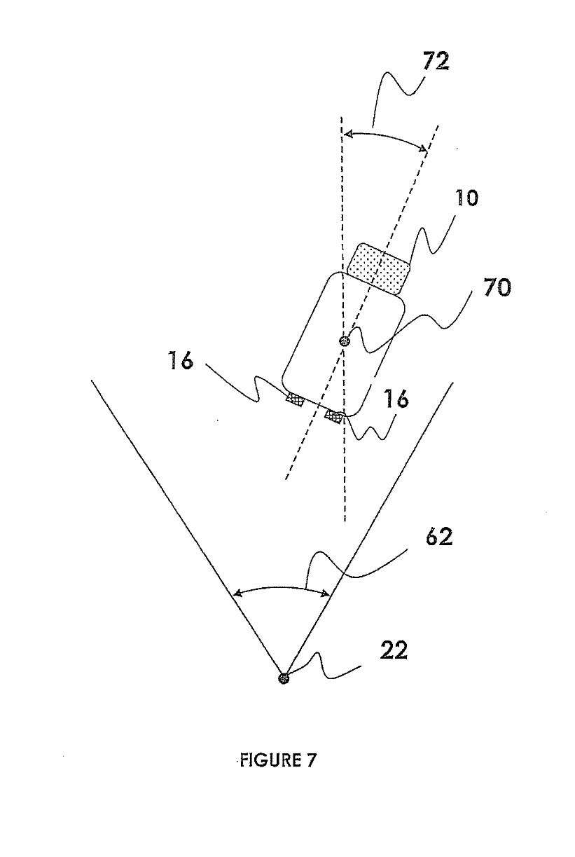

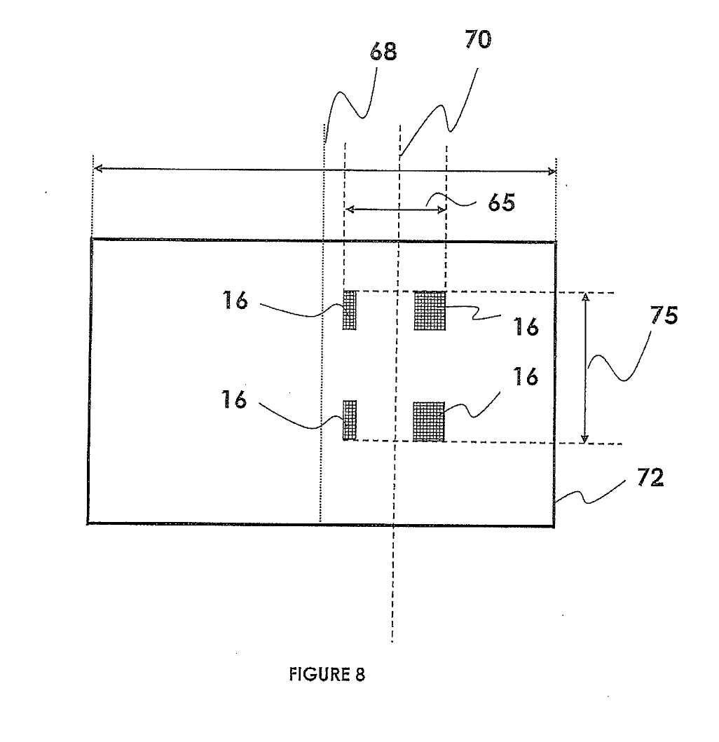

FIG. 7 represents a plan view of the field of view of sensing device 22 with respect to the tilt 72 of leader vehicle 10 about its central axis 70. FIG. 8 shows a corresponding image view of the same tilt 72 of leader vehicle 10 about its central axis 70 in FIG. 7.

With reference to FIG. 7, leader vehicle 10 is making a right turn. At a given moment in time, the imaging system is able to detect the tilt 72 of leader vehicle 10 about its central axis 70. A corresponding image of the same tilt of leader vehicle 10 is shown in FIG. 8. As marker devices 16 on the left side of leader vehicle 10 are further away from sensing device 22, the horizontal distance between the marker devices in number of pixels 65 (HorDₚᵢₓₑₗ) shown on the image will appear to be smaller. The vertical distance between marker devices 16 in number of pixels (VerDₚᵢₓₑₗ) 75 is also used in the calculation of the tilt reading. The actual vertical distance, VerD_{actual} between the marker devices disposed on leader vehicle 10 is a fixed variable and is predetermined. The tilt of the leader vehicle is therefore calculated as follows:

Tilt=Inv cos[(HorDₚᵢₓₑₗ×VerD_{actual})/(VerDₚᵢₓₑₗ×HorD_{actual})]

Another advantageous feature according to a preferred embodiment of the present invention is the alert or alarm system (not shown) provided by the imaging system when the leader object is no longer within the field of view of the sensing device. The alert system warns the operator that convoy contact has been broken and to regain convoy contact as soon as possible. The leader object is to slow down or stop before regaining contact.

It should be appreciated that the invention herein is applicable to a convoy comprising more than two vehicles or objects. One leader vehicle could have two or more follower vehicles, or a follower vehicle could function as a leader vehicle for another follower vehicle, which could in turn function as a leader vehicle for another follower vehicle, and so on.

Although the invention has been herein shown and described in what is conceived to be the most practical and preferred embodiment, it is recognized that departures can be made within the scope of the invention, which is not to be limited to the details described herein but is to be accorded the full scope of the appended claims so as to embrace any and all equivalent devices and apparatus.

‘Comprises/comprising’ when used in this specification is taken to specify the presence of stated features, integers, steps or components but does not preclude the presence or addition of one or more other features, integers, steps, components or groups thereof.

We claim:

1. An imaging system for tracking the location and direction of movement of a first object, comprising:
a plurality of marker devices adapted to be disposed in a pattern on the first object;
a sensing device adapted to be disposed on a second object so as to view the marker devices, the sensing device being operative to detect the relative positions of the plurality of marker devices on the first object; and a processor coupled to the sensing device to form an image of the relative positions of the plurality of marker devices and to determine the direction of movement of the first object,
wherein the relative positions of the marker devices on the image allows the rotation of the first object about its own axis to be determined such that the direction of movement of the first object can be tracked.

2. The imaging system according to claim 1, wherein the plurality of marker devices comprises at least four marker devices.

3. The imaging system according to claim 1, wherein each of the marker devices is spaced apart from each other.

4. The imaging system according to claim 3, wherein the distances between each of the marker devices are substantially equal.

5. The imaging system according to claim 3, wherein the marker devices are arranged in a substantially square configuration, with one marker device in each corner.

6. The imaging system according to claim 1, further comprising a digital processing unit operatively connected to the sensing device, wherein the digital processing unit obtains at least a parameter from the image for determining the distance, bearing or rotation of the first object about its own axis with respect to the second object.

7. The imaging system according to claim 6, wherein the parameters include horizontal distance in number of pixels between the marker devices.

8. The imaging system according to claim 6, wherein the parameters include vertical distance in number of pixels between the marker devices.

9. The imaging system according to claim 1, wherein the plurality of marker devices emit infrared energy.

10. The imaging system according to claim 3, wherein the at least one of the plurality of marker devices further comprises a conductive plate, a temperature controller, and a power controller module.

11. The imaging system according to claim 3, wherein the conductive plate maintains a temperature difference between the temperature of the first object and the conductive plate such that the sensing device can detect the marker devices on the first object.

12. The imaging system according to claim 11, wherein the temperature difference is at least 10° C.

13. The imaging system according to claim 11, wherein the temperature controller regulates the temperature of the conductive plate by heating or cooling the conductive plate such that a temperature difference between the temperature of the first object and the conductive plate is maintained.

14. The imaging system according to claim 1, wherein each of the first object and the second object is an unmanned or manned vehicle.

15. The imaging system according to claim 1, wherein the marker devices are removably mounted on the rear end of the first object.

16. The imaging system according to claim 1, wherein the relative positions of the marker devices on the image allows the rotation of the first object about its own axis to be determined such that the direction of movement of the first object can be tracked.

17. An imaging system for tracking the direction of movement of a first object, comprising:
a plurality of marker devices adapted to be disposed on the first object; and
a sensing device adapted to be disposed on a second object,
wherein the sensing device is adapted for detecting the relative positions of the plurality of marker devices on the first object and forming an image of the relative positions of the plurality of marker devices.

18. A method for tracking the direction of movement of a first object, comprising the steps of:
receiving images of relative positions of a plurality of marker devices adapted for disposing on the first object, said images captured from a sensing device adapted for disposing on a second object;
obtaining from the images parameters based on the relative positions of the plurality of marker devices;
processing the parameters to obtain the distance, bearing and rotation of the first object with respect to the second object such that the direction of movement of the first object with respect to the second object can be determined.

19. A method according to claim 18, wherein the plurality of marker devices include at least four marker devices.

20. A method according to claim 18, wherein the plurality of marker devices are each spaced apart from each other.

21. A method according to claim 20, wherein the plurality of marker devices are arranged in a substantially square configuration, with one marker device in each corner.

22. A method according to claim 18, wherein the parameters include the horizontal distance in number of pixels of the marker devices.

23. A method according to claim 22, wherein the parameters include the vertical distance in number of pixels of the marker devices.

23. A method for tracking the direction of movement of a first object, relevant to a second object, which method comprises:
generating signals regarding relative positions of a plurality of marker devices disposed on the first object;
receiving said signals in a sensing device disposed on the second object;
providing images based upon said signals in a display;
obtaining from the images parameters based on the relative positions of the plurality of marker devices; and
processing the parameters to obtain the distance, bearing, and rotation of the first object with respect to the second object such that the direction of movement of the first object with respect to the second object can be determined.
